(19) United States
(12) Patent Application Publication
(10) Pub. No.: US 2026/0289371 A1
(43) Pub. Date: Sep. 24, 2026

(54) Bosonic Computing with Integrated Nanomechanical Resonators and Solid-State Spins

(71) Applicant: Massachusetts Institute of Technology, Cambridge, MA (US)

(72) Inventors: Hamza Raniwala, Cambridge, MA (US); Ethan G. Arnault, Stoneham, MA (US); Dirk Robert ENGLUND, Brookline, MA (US); Matthew Edwin TRUSHEIM, Cambridge, MA (US)

(21) Appl. No.: 19/572,441

(22) Filed: Mar. 19, 2026

Related U.S. Application Data
(60) Provisional application No. 63/774,713, filed on Mar. 19, 2025.

(51) Int. Cl. G06N 10/40; B82Y 10/00; B82Y 40/00

(52) U.S. Cl. CPC G06N 10/40; B82Y 10/00; B82Y 40/00

(57) ABSTRACT

Nanomechanical structures have been heavily investigated in the last decade as a method of achieving long-lived quantum excitations at radiofrequencies. This makes mechanical modes especially intriguing as a medium for bosonic encoding of quantum information. However, up to second order, mechanical modes typically lack nonlinearities used to achieve communication between bosonic channels and thus are limited in their ability to scale to the many-qubit regime necessary for practical quantum computing. Here, we disclose an approach for bosonic computing with mechanical modes weakly coupled through solid state spin nonlinearities. We outline an architecture for achieving nearest-neighbor connectivity between mechanical cat state qubits on-chip, as well as an accompanying control and readout architecture.

### CROSS-REFERENCE TO RELATED APPLICATION(S)

This application claims the priority benefit, under 35 U.S.C. 119(e), of U.S. Application No. 63/774,713, filed on Mar. 19, 2025, which is incorporated by reference herein in its entirety for all purposes.

### BACKGROUND

Quantum information processing is predicated on using long-lived quantum modalities in an error-correctable computation scheme to achieve a quantum circuit. To date, large-scale efforts to achieve quantum error correction have focused on implementing surface codes, which have been shown to demonstrate sub-threshold error correction for increasing code distance, d. However, surface-codes are resource intensive, using ~d² physical qubits per logical qubit, causing the quantum information density to be sparse. Ultimately, such resource-intensive schemes may be a bottleneck to scaling.

An alternative approach is to perform bosonic encoding, which leverages the infinite dimensional Hilbert-space of a harmonic oscillator to encode information. Typical approaches to bosonic encoding utilize bosonic modes such as microwave electromagnetic cavities coupled to nonlinear superconducting circuits, e.g., transmons. These modalities have been proposed and implemented in quantum error correction schemes with logical information lifetimes greater than the modality's physical lifetime. However, using microwave circuitry to achieve a bosonic mode is costly in size and the relevant decay timescales: the three-dimensional microwave cavities needed to achieve lifetimes greater than milliseconds are cubic centimeters in size, and the nonlinear ancilla transmons have typical dephasing times on the order of tens of microseconds. This leaves a narrow time during which quantum operations can be performed on the bosonic cavity (since the transmon should be coherent during cavity operations) and few prospects for scaling to millions of qubits and beyond to exit the noisy intermediate state quantum (NISQ) regime.

Contrasting the large dimensions required to house a microwave radiation mode, mechanical resonators can be cubic microns in size. Indeed, the acoustic velocity in most materials is roughly four orders of magnitude smaller than the speed of light in a vacuum. Thus, a relatively large mechanical mode should occupy less space on-chip than a microwave transmission line resonator with shorter lifetimes. Despite this size difference, mechanical modes lack a native nonlinearity to first or second order in most materials, and thus preparation of a quantum state such as a cat state would be difficult. Piezoelectrics and superconducting transmons can be used to circumvent this issue. However, transmons suffer in both size constraints and qubit lifetimes, limiting the efficacy of a space-efficient platform.

### SUMMARY

Here, we disclose using mechanical resonators with nonlinear atomic defect spins in solid state as the ancillary two-level systems for quantum state preparation in the mechanical resonators. Unlike transmons, the spin degrees of freedom of atomic defects are long lived, with pure dephasing times surpassing 100 μs and dynamically decoupled dephasing times approaching one millisecond. Thus, a spin coupled to a mechanical resonator would allow for many more quantum operations on a mechanical mode (e.g., a vibrational mode) within its decay time than a transmon would allow for an analogous system. This reverses proposals which use spins as the encoding qubit and mechanical modes as a mediating interaction, therefore confining logical quantum information to a much smaller device area.

Diamond lends itself as a unique platform for this mechanical resonator-defect architecture. Diamond spins are bright, long-lived emitters with spin-orbit susceptibilities approaching PHz and, as a result, projected MHz-scale spin-phonon coupling rates. Additionally, Group IV emitters such as SnV and SiV complexes have fast decay times for high-fidelity single-shot readout, which is orders of magnitude higher fidelity than typical superconducting readout schemes. Thus, among platforms with optically active defects, diamond is a desirable host material for this bosonic encoding approach.

Our platform for bosonic encoding leverages the compact nature of nanomechanical oscillators and the nonlinearity of diamond vacancy centers. We demonstrate our platform's ability to encode bosonic states into the nanomechanical oscillator by generating a cat state. Using single-shot optical readout of the spin we can perform parity checks and Wigner function tomography of the cat state. By leveraging a spin-bus protocol, we can generate entanglement between two adjacent cat states, with realistic fidelities exceeding 90%. Ultimately, our bosonic encoding platform enables a spatially dense logical encoding of quantum information.

An example bosonic encoding device including first and second nanomechanical resonators, which support first and second sets of bosonic modes, respectively, and first, second, and third spin qubits. The first spin qubit is coupled to the first nanomechanical resonator and manipulates and reads out quantum information encoded in the first set of bosonic modes. Likewise, the second spin qubit is coupled to the second nanomechanical resonator and manipulates and reads out quantum information encoded in the second set of bosonic modes. And the third spin qubit is coupled to the first and second nanomechanical resonators and controllably couples the first and second sets of bosonic modes so as to entangle the quantum information of the first set of bosonic modes with the quantum information of the second set of bosonic modes.

The first and second nanomechanical resonators can be formed in a diamond substrate, in which case the first, second, and third spin qubits are each one of a silicon vacancy (SiV) or tin vacancy (SnV) formed in the diamond substrate.

The first and second nanomechanical resonators can each have a quality factor of 10⁵ to 10⁷. The first and second nanomechanical resonators can occupy respective areas each less than 10,000 μm².

The bosonic encoding device of claim 1, wherein the first nanomechanical resonator and the second nanomechanical resonator are in a one-dimensional array of nanomechanical resonators.

The first set of bosonic modes can be detuned in frequency from the second set of bosonic modes.

The third spin qubit can be formed in a bridge connecting the first and second nanomechanical resonator.

The bosonic encoding device can also include first and second piezoelectric transducers mechanically coupled to the first and second nanomechanical resonator, respectively. In operation, the first and second piezoelectric transducers drive the first and second sets of bosonic modes, respectively.

The bosonic encoding device can also include first, second, and third superconducting loop, in electromagnetic communication with the first, second, and third spin qubits, respectively, to tune resonances of the first, second, and third spin qubits.

Other embodiments include a method of entangling quantum information in a first set of bosonic modes supported by a first nanomechanical resonator with quantum information in a second set of bosonic modes supported by a second nanomechanical resonator using a spin qubit located where the first set of bosonic modes overlap with the second set of bosonic modes. In this method, quantum information is encoded in the first and second sets of bosonic modes. The spin qubit is then tuned to interact dispersively with the first set of bosonic modes and the second set of bosonic modes, thereby entangling the quantum information encoded in the first set of bosonic modes with the quantum information encoded in the second set of bosonic modes.

Encoding the quantum information in the first set of bosonic modes can include straining the first nanomechanical resonator with a first piezoelectric transducer at a first frequency. In this case, encoding the quantum information in the second set of bosonic modes can include straining the second nanomechanical resonator with a second piezoelectric transducer at a second frequency different than the first frequency.

Tuning the spin qubit can include applying a magnetic field and/or a microwave field to the spin qubit.

If desired, the quantum information encoded in the first set of bosonic modes can be manipulated and/or read out with an ancilla spin qubit in the first nanomechanical resonator.

Another example bosonic encoding device includes an array of nanomechanical resonators and an array of ancillary coupling spins. Each nanomechanical resonator in the array of nanomechanical resonators supports a corresponding set of bosonic modes and contains a corresponding ancillary spin qubit to manipulate and read quantum information encoded in the corresponding set of bosonic modes. And each ancillary coupling spin in the array of ancillary coupling spins controllably couples of the sets of bosonic modes of an adjacent pair of nanomechanical resonators in the array of nanomechanical resonators.

The array of nanomechanical resonators can be formed in a substrate, in which case the ancillary coupling spins can be formed in respective bridges connecting respective adjacent pairs of nanomechanical resonators in the array of nanomechanical resonators.

The sets of bosonic modes of the adjacent pairs of nanomechanical resonators can be detuned from each other.

Each nanomechanical resonator in the array of nanomechanical resonators can occupy an area of less than 10,000 μm² (e.g., 5000 μm², 2500 μm², 1000 μm², or less).

This bosonic encoding device can also include an array of piezoelectric transducers, each of which is configured to drive a corresponding nanomechanical resonator in the array of nanomechanical resonators.

All combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. Terminology explicitly employed herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A illustrates a bosonic encoding device with piezoelectric transducers driven by a microwave tone coupled via an interdigitated capacitor. Each spin can be optically addressed for spin polarization and readout.

FIG. 1B illustrates a unit cell of the bosonic encoding device of FIG. 1B that contains three qubits.

FIG. 1C shows spin (left) and nanomechanical (right) energy diagrams. The spin has two optically addressed manifolds which can be split into two spin states. The spin is coupled with strength, g, to the nanomechanical resonator.

FIG. 1D is an energy diagram of the full unit cell of FIG. 1B. By driving q_{c} via the superconducting cables, it is possible to perform two qubit operations between the two logical cells.

FIG. 2A illustrates a cat state preparation scheme for the bosonic encoding platform.

FIG. 2B is plot of fidelity (left axis) and amplitude (right axis) versus time for the coherent state encoded by a bosonic encoding device.

FIG. 2C is an energy diagram representing single-shot optical readout in a bosonic encoding device.

FIG. 2D shows readout histograms distinguishing the spin-up (left) and spin-down (right) states entangled with the odd and even cat states, respectively. The dotted vertical line at counts=1 represents the state distinguishing threshold.

FIG. 2E shows the Wigner distribution of an odd cat state with negative Wigner contribution at the origin and therefore even parity, heralded with the spin-up state.

FIG. 2F shows the Wigner distribution of a cat state with odd parity, heralded with the spin-down state.

FIG. 3A illustrates a spin-enabled Wigner tomography scheme using bosonic encoding.

FIG. 3B is a plot of spin population evolution under dispersive interaction with the phonon for different phonon states, including the odd and even cat states in FIGS. 2C and 2D.

FIG. 3C is a plot of the spin population averaged over 1000 Monte Carlo simulated tomography experiments with varying real displacement of the even cat state.

FIG. 4A illustrates a CNOT entanglement scheme using bosonic encoding.

FIG. 4B is a plot of Bell state fidelity versus quality factor for a mean photon number of n̅=2.5.

FIG. 4C is a plot of Bell state fidelity versus mean photon number, n̅, for a quality factor of Q=106.

### DETAILED DESCRIPTION

An inventive platform for bosonic quantum computing leverages nanomechanical resonators coupled to diamond vacancy center spins. The nanomechanical resonators have footprints ranging from on the order of a square micron to on the order of up to 10,000 square microns, offering a path toward information densities far exceeding those of microwave cavity or surface code architectures, while the long coherence times of diamond spins provide a wider operational window than transmon-based approaches.

A single ancilla spin qubit, also called a spin ancilla, assists in computations without storing primary data and can be dispersively coupled to a nanomechanical resonator. This spin ancilla can prepare a cat state, or quantum superposition of two macroscopically distinct bosonic modes, of the nanomechanical resonator with a fidelity of 75-80% for a coherent state amplitude α from 2 to 5. These cat states exhibit lifetimes on the order of tens of microseconds for realistic resonator quality factors of ~10⁷. Single-shot optical readout of the spin ancilla enables high-fidelity parity measurement of the bosonic mode, with estimated readout fidelities exceeding 95%. A spin-bus protocol mediated by an ancillary coupling spin makes it possible to perform two-qubit entangling gates between neighboring cat state qubits with fidelities of 87-89% at moderate photon numbers.

A single unit cell comprised of a nanomechanical resonator with a single spin ancilla is sufficient to prepare a single bosonic encoded qubit (here, there is one bosonic mode per vibrational mode of the nanomechanical resonator, so the terms “bosonic mode” and “vibrational mode” are synonymous with respect to the nanomechanical resonator(s)). Two unit cells interact with one another via another spin ancilla, also called an ancillary coupling spin. This ancillary coupling spin can interact via spin-strain interaction with the overlapping vibrational modes of the two unit cells in a common bridge region that connects the nanomechanical resonators. The vibrational modes overlap spatially at the location of the ancillary coupling spin, so the nanomechanical resonators of neighboring unit cells should differ from one another such that their vibrational modes are separated in frequency space and do not hybridize with one another (i.e., form a common vibrational mode that spans both unit cells) at a single frequency.

Each unit cell features control knobs on the nanomechanical resonator and each spin. The nanomechanical resonator features a piezoelectric transducer that enables coherent driving of the nanomechanical resonator's vibrational (bosonic) mode(s). This transducer can take different forms, such as a surface acoustic wave transducer including a piezoelectric thin film with interdigitated capacitor, or other acoustic transducer, which can generate a vibrational excitation at the frequency of the nanomechanical resonator's vibrational mode, thereby creating oscillations in displacement-momentum space.

The spin ancilla can be controlled with a magnetic field, a microwave field, and/or an optical field. The magnetic field control can be delivered via a superconducting current loop that can carry both DC current and AC current. The DC current generates a magnetic field that shifts the spin ancilla in and out of frequency resonance with the vibrational mode of the nanomechanical resonator, thereby coupling or de-coupling the vibrational mode and the spin of the spin ancilla, while the AC current provides a coherent microwave drive that manipulates the spin state between two states (e.g., up or down).

The optical excitation is a coherent laser excitation from a laser at the optical resonance of the color center to which the spin ancilla belongs. This laser allows for nondestructive optical readout of the spin state of the spin ancilla: when the spin is, for example, up, the color center will fluoresce under laser excitation, and when the spin is, for example, down, the color center will not fluoresce, resulting in a thresholded detection of the spin state without destroying the encoded quantum information. The laser excitation may be delivered via free space optical microscopy, optical fiber, or on-chip photonic structures that guide light to the location of the spin ancilla.

An ancillary coupling spin that couples two unit cells is also controlled with a magnetic field, a microwave driving field, and/or an optical excitation. The magnetic field control allows precise tuning of the ancillary coupling spin such that the strength of ancillary coupling spin's dispersive interactions with the vibrational modes of the neighboring nanomechanical resonators can be made equal. A microwave drive on the ancillary coupling spin is sufficient to “turn on and off” the ancillary coupling spin's interaction with the neighboring modes-when the ancillary coupling spin is in the spin up state, the ancillary coupling spin will dispersively interact with the neighboring vibrational modes, and when the ancillary coupling spin is in the spin down state, this interaction will cease, allowing the unit cells to couple to one another for desired interaction periods.

### Spin-Mechanical Bosonic Encoding Device

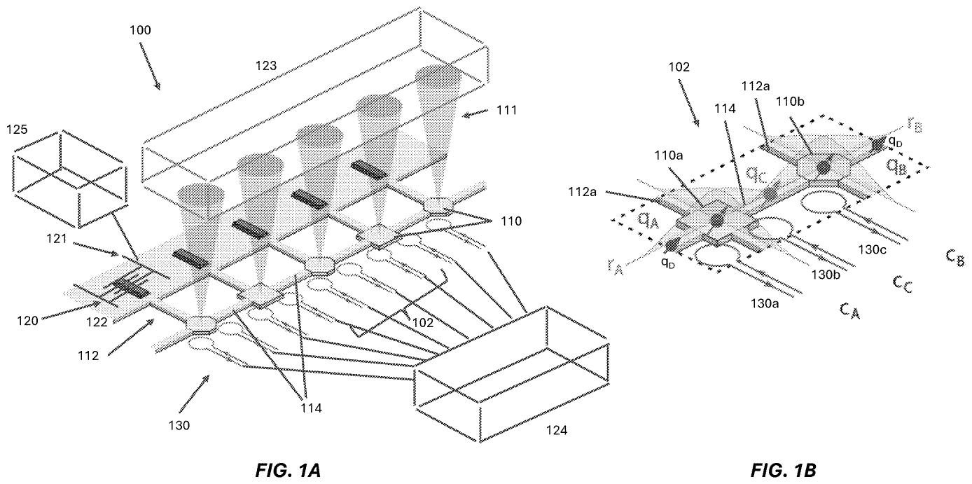

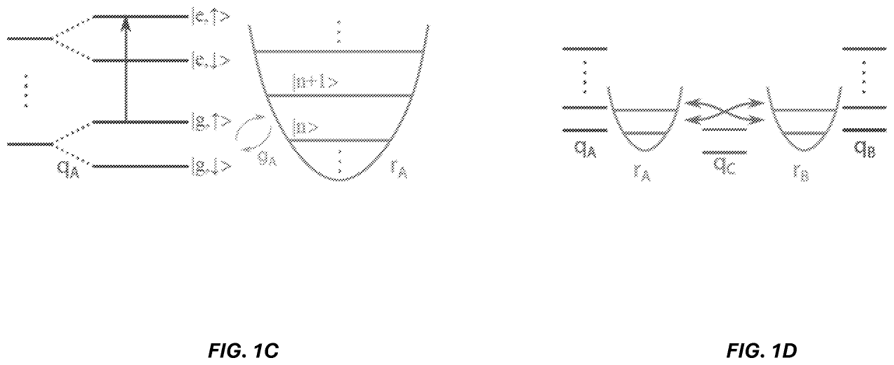

FIGS. 1A-1D illustrates a bosonic encoding device 100 with piezoelectric transducers 120 driven by a microwave tone coupled via an interdigitated capacitor 121. The piezoelectric transducers 120 are formed on a substrate 122 (e.g., a diamond substrate) that has been patterned to form a set of cantilevers 112 that end in a one-dimensional (1D) array of interconnected nanomechanical resonators 110, also called phononic resonators, with one piezoelectric transducer 120 per nanomechanical resonator 110. Each piezoelectric transducer 120 and nanomechanical resonator 110 forms a unit cell, also called a logical cell or logical unit cell, of the bosonic encoding device 100.

In operation, applying a voltage to a given piezoelectric transducer 120 strains the corresponding cantilever 112, which in turn drives the nanomechanical resonator 110 at the end of that cantilever 112. Arms or bridges 114 connect each nanomechanical resonator 110 to the neighboring nanomechanical resonators 110 in the array. Neighboring nanomechanical resonators 110 in the 1D array have different sizes and/or shapes and, as a result, support vibrational (bosonic) modes with different resonance frequencies. FIGS. 1A and 1B show square and octagonal nanomechanical resonators 110, but other shapes are also possible. The piezoelectric transducer is driven by a microwave source 125, such as an arbitrary waveform generator or radiofrequency synthesizer.

The bosonic encoding device 100 also includes ancilla qubits in the form of spin qubits q, also called spin defects, defect centers, or color centers. These ancilla spin qubits q assist in computations without storing primary data. There is one spin qubit in each nanomechanical resonator 110 and one spin qubit in each arm or bridge 114. If the substrate 122 is a diamond substrate, then the spin qubits q may be tin vacancies (SnV) or silicon vacancies (SiV). The spin qubits q can be addressed with laser beams 111 provided by a laser source 123, such as a tunable diode laser, for spin polarization and readout.

FIG. 1B illustrates a pair 102 of coupled unit cells of the bosonic encoding device 100 of FIG. 1A that contains two nanomechanical resonators 110a and 110b, one bridge 114 connecting the nanomechanical resonators 110a and 110b, and three spin qubits q_{A}, q_{B}, and q_{C}—spin ancillae q_{A} and q_{B} and ancillary coupling spin q_{C}. Superconducting wire loops 130a, 130b, and 130c carry current to control the spin qubits q_{A}, q_{B}, and q_{C}, respectively. Spin qubits q_{A} and q_{B} are formed in and individually coupled to the vibrational (bosonic) modes r_{A} and r_{B} of the nanomechanical resonators 110a and 110b, respectively. Each spin/nanomechanical resonator pair acts as a separate logical cell. The spin qubit q_{C} is in a region of the bridge 114 where the bosonic (vibrational) modes r_{A} and r_{B} overlap and where it acts as a coupling spin qubit that ties together the unit cells. Logical information is encoded in the bosonic states of each nanomechanical resonator 110, which can be driven by a corresponding piezoelectric transducer 120 and addressed by the spin qubit q contained in that nanomechanical resonator 110. In other words, spin qubits q_{A} and q_{B} are used to initialize bosonic states in r_{A} and r_{B}, while q_{C} is used to couple r_{A} and r_{B}. Additional ancilla spin qubits q_{D} in the bridges 114 that connect the nanomechanical resonators 110a and 110b are controlled by respective magnetic, microwave and optical fields and couple adjacent pairs of unit cells.

Each pair of unit cells 102 also includes two piezoelectric input ports (cantilevers 112a and 112b; one per unit cell/nanomechanical resonator 110) coupled to r_{A} and r_{B}, respectively, for populating the bosonic modes of the nanomechanical resonators 110a and 110b via strain. Additionally, the ancilla spin qubits q_{A} and q_{B} can be probed with laser beams 111 for nondestructive readout of the nanomechanical resonators 110. Each unit cell pair 102 features frequency tuning knobs in the form of superconducting current loops c_{A,B,C} for each ancillary spin qubit q_{A,B,C}. These superconducting current loops c_{A,B,C} are powered by a current source 124 and allow for tuning of the spin qubit modes by up to 300 MHz, limited by the critical current density of the superconducting wires (for Nb, 10⁵ A/cm²). These control elements—in sum, a piezoelectric driving and optical readout layer and a superconducting tuning layer—provide full qubit functionality over a single unit cell pair 102.

FIG. 1C shows the spin qubit (left) and nanomechanical resonator (right) energy diagrams for a single logical cell (spin qubit/nanomechanical resonator) in the pair of unit cells 102 of FIG. 1B. The spin qubit has two optically addressed manifolds which can be split into two spin states. The spin qubit is coupled with a strength g to the corresponding nanomechanical resonator.

FIG. 1D is an energy diagram of the unit cell pair 102 of FIG. 1B. By driving the coupling qubit q_{C} via the superconducting wire c_{C}, it is possible to perform two qubit operations between the two logical cells (spin qubit/nanomechanical resonator) in the pair of unit cells 102. The unit cell Hamiltonian, with energy levels labeled in FIG. 1C, includes the bare Hamiltonian H_{cell,0} and interaction Hamiltonian H_{cell,int}:

$$\frac{{H}_{c e l l , 0}}{ℏ} = {\sum }_{i = A , B} {ω}_{R , i} {a}_{i}^{†} {a}_{i} + {\sum }_{i = A , B , C} \frac{{ω}_{S , i}}{2} {σ}_{z , i} ;$$

$$\frac{{H}_{cell , int}}{ℏ} = {\sum }_{i = A , B} {\sum }_{j = A , B , C} ( {g}_{{x}_{i , j}} {σ}_{x , j} + {g}_{{z}_{i , j}} {σ}_{z , j} ) ( {a}_{i} + {a}_{i}^{†} ) .$$

This interaction Hamiltonian can be rewritten in the rotating wave approximation (RWA) as the Jaynes Cummings Hamiltonian between each resonator and two-level system ancilla,

$$\frac{{H}_{cell , int}}{ℏ} = {\sum }_{i = A , B} {\sum }_{j = A , B , C} {g}_{i , j} ( {σ}_{+ , j} {a}_{i} + {σ}_{- , j} {a}_{i}^{†} ) .$$

In the limit where the interaction between r_{A} and r_{B} is small due to mode isolation, the coupling terms g_{A,B}~g_{B,A}~0. The crosstalk between r_{A} and r_{B} is further suppressed by the frequency mismatch between the resonant modes.

In the dispersive limit, when a given mode i and ancilla j are detuned by a frequency Δ_{i,j}>>g_{i,j}, the interaction Hamiltonian can be expressed in the dispersive regime as

$$\frac{{g}_{i , j}^{2}}{{Δ}_{i , j}} {a}_{i}^{†} {σ}_{z , j} = {χ}_{i , j} {a}_{i}^{†} {a}_{i} {σ}_{z , j} .$$

The tunability of the ancillary spin qubits q_{A,B,C} enables movement between the Jaynes Cummings and dispersive regimes, providing full spin-mediated quantum control of the nanomechanical resonators 110 as bosonic logical qubits.

### Demonstration and Performance of Bosonic Encoding

To demonstrate the ability of the bosonic encoding device 100 of FIGS. 1A-1D system to encode logical information in the nanomechanical (phononic) resonators, we modeled the creation of a cat state in a single logical cell of the bosonic encoding device 100. To capture the dynamics of the bosonic encoding device, we numerically modeled the evolution of the wavefunction under the influence of realistic decay channels using quantum Monte-Carlo. TABLE 1 shows the parameters used in this simulation:

TABLE 1
Parameters used in the quantum Monte-Carlo Simulation

| Qᵣₑₛ | T_{1, spin} ms | g (MHz) | fᵣₑₛ (GHz) | Δ (MHz) | α | η |
|---|---|---|---|---|---|---|
| 10⁷ | 1 | 2 | 5.4 | 200 | 3 | 1000 |

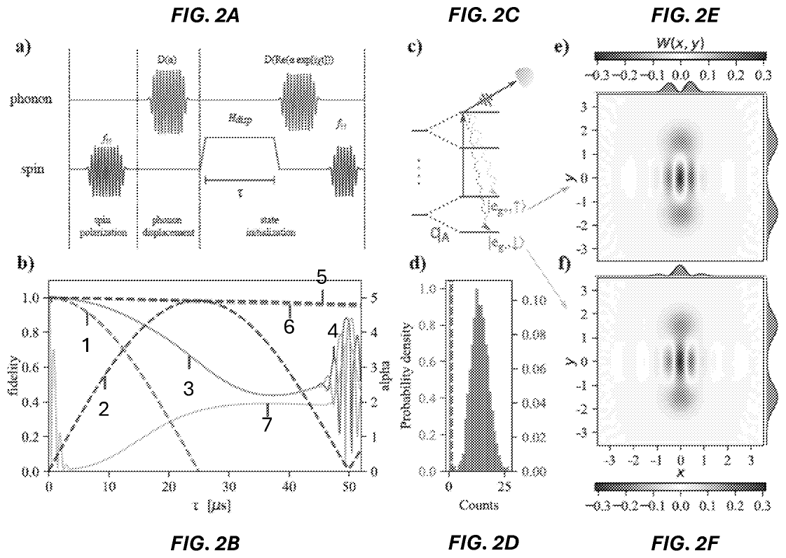

FIG. 2A illustrates the following procedure for initializing the bosonic encoding device:
1. Drive the piezoelectric transducer to initiate a coherent state with an amplitude α (set to 3 in FIG. 2A);
2. Initialize the spin qubit to (1/\sqrt{2})(|↓ [symbol] +|↑ [symbol] ), e.g., with an optical drive and a π/2 rotation;
3. Tune the spin frequency to dispersively interact with the phononic resonator with interaction rate χ=g²/Δ, allowing the system to evolve roughly as |ψ(t) [symbol] =|αe⁻ⁱ^{_{χ}}^{t} [symbol] |↑ [symbol] +e^{iφ}|αeⁱ^{_{χ}}^{t} [symbol] ↓ [symbol] , where φ is the relative phase accumulated by the qubit ground state during unitary evolution;
4. Displace the coherent state back to the origin and apply a π/2 rotation on the spin to generate the state

$$\vert {ψ}_{f} ( t ) 〉 = ( \vert iIm ( α {e}^{- i χ t} ) 〉 - {e}^{i Φ} \vert - iIm ( α {e}^{- i χ t} ) 〉 ) \vert ↑ 〉 = i ( \vert iIm ( α {e}^{- i χ t} ) 〉 + {e}^{i Φ} \vert - iIm ( α {e}^{- i χ t} ) 〉 ) \vert ↓ 〉$$

5. Read out the spin state to herald on the positive or negative cat state,

$$\vert {𝒞}_{\pm } ( α ) 〉 = \vert iIm ( α {e}^{- i χ t} ) 〉 \pm {e}^{i Φ} \vert - iIm ( α {e}^{- i χ t} ) 〉 .$$

FIG. 2B is a plot of the system evolution over time during the dispersive interaction. The dotted lines 1 and 2 represent the real and imaginary displacement, respectively, of the coherent state in quasi-probability space, where the real component is the amount by which the state must be shifted to achieve the initial states. The solid lines 3 and 4 represent the even and odd cat state purities, respectively, while the dotted lines 5 and 6 represent their respective magnitudes. The solid line 7 represents the orthogonality of the even/odd cat states.

### Wigner Tomography Via Single-Shot Spin Readout

FIG. 2C depicts a protocol for performing a parity check readout scheme of the ancilla spin qubit in order to read out the Wigner function. The protocol begins with displacing the phonon mode (e.g., r_{A} or r_{B} in FIG. 1B) in position-momentum space by driving the nanomechanical resonator with the piezoelectric transducer by some β such that the phonon mode overlaps with the spin. Next, we dispersively couple the spin qubit to the phononic cavity by using DC current supplied by the superconducting current loop to tune the resonant frequency of the spin qubit to be detuned from the bosonic mode of the nano mechanical resonator at a detuning appropriate for the dispersive coupling regime for a time τ, thereby mapping the parity of the phonon onto the spin. Finally, we apply a π/2 gate to the spin qubit and readout the spin qubit by driving the spin qubit with AC current supplied by the superconducting current loop.

One advantage of utilizing diamond color centers is the ability to exploit the single-shot optical readout scheme. FIG. 2D is a histogram that shows the result of this readout scheme, with counts that represent the “clicks” of a photodetector used for single-shot optical readout. Oscillations in the counts map to the quantum interference pattern of the cat state Wigner function. Thus, we can use the single-shot optical readout of the spin to perform parity readout of the cat state.

FIGS. 2E and 2F show the Wigner distributions of, respectively, a cat state with negative Wigner contribution at the origin and even parity, heralded with the spin-up state, and of a cat state with odd parity, heralded with the spin-down state. These even and odd cat states can serve as orthogonal states of the bosonic encoded qubit in the nanomechanical resonator. Other bosonic encodings are possible by initializing different orthogonal bosonic states in place of the depicted cat states.

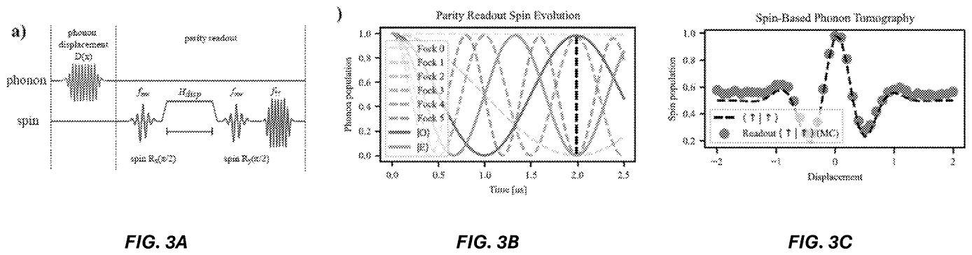

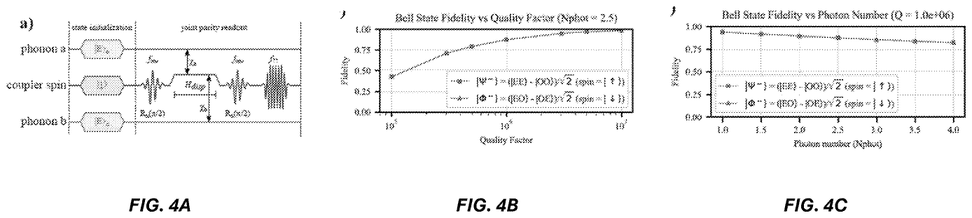

Next, we benchmark the single-shot optical parity readout of our cat state. The readout fidelity is defined as

$${F}_{r e a dout} = 1 - ( P ( + \vert - ) - P ( - \vert + ) ) / 2 ,$$

where P(+|−) and P(−|+) are the false positive and false negative detection probabilities. We perform quantum Monte Carlo simulations and measure the stochastic collapse of the quanta into the optically measured “bright” and “dark” states corresponding to positive and negative Wigner quasiprobability as a function of time (FIG. 3B). For positive Wigner quasiprobability, the spin is initially in the IT) state, which is bright (i.e., high in photon counts) when optically driving the |g, ␣ [symbol] →|e, ↓) transition. Conversely, for negative Wigner quasiprobability, the emitter is in the dark (i.e., low in photon counts) |g, ↓) state. FIG. 2D shows histograms of the single-shot optical readout and define a threshold (red dashed line) at a count of 1 that minimizes the error probability. The estimated single shot optical parity readout is ~0.95.

### Implementation of One- and Two-Qubit Gates

We now describe the gate operations for performing complete gate-based quantum computations on our bosonic encoding platform. The minimum required gate sets for this quantum computing platform include the following single-qubit gates:
Rotation about the x axis of the Bloch sphere, Rₓ(θ); and
Rotation about the z axis of the Bloch sphere, R_{z}(θ),
   as well as the following two-qubit gates:
SWAP gate; and
CNOT gate.

Suppose that we select our logical states to be |0 [symbol] =|E [symbol] =|α [symbol] +|−α [symbol] and |1 [symbol] =|0 [symbol] =|α [symbol] +|−α [symbol] . Then a rotation about the x-axis of the Bloch sphere from (e.g., from logical |0 [symbol] =|α [symbol] ) can be accomplished using a conditional dispersive shift with the ancilla qubit. A rotation about the z-axis can be performed using small displacement operations D(∈) that change the parity of the cat state. In this way, ancilla-dependent and classical displacement operations permit full control over each individual qubit. In practice, gates can be optimized using the gradient ascent pulse engineering (GRAPE) protocol, which has been deployed for analogous quantum systems.

To perform a two-qubit operation, we use the ancillary spin qubit q_{C} between the nanomechanical resonators with modes r_{A} and r_{B} to implement an entangling gate. This entangling gate can be accomplished using a combination of a joint-parity readout and single-qubit gates. The joint-parity readout operation P is as follows:
1. Initialize q_{C} in the ground state;
2. Tune q_{C} so that it interacts dispersively with r_{A} and r_{B}, with dispersive interaction rates

$${χ}_{A / B} = \frac{{g}_{A / B , C}^{2}}{{Δ}_{A / B}} ;$$

3. Allow the system to evolve under this dual dispersive coupling interaction; and
4. After time τ_{parity}, perform a parity readout on c_{C}.

This dispersive interaction can be tuned by the ratio χ_{A}/χ_{B}, such that selected parity states result in the ancillary spin qubit q_{C} spin-up and/or spin-down, enabling a control operation with the ancillary spin qubit q_{C}.

If the phonon numbers in resonator modes r_{A} and r_{B} are jointly even (i.e., even/even or odd/odd), then the coupling spin qubit q_{C} will be in the |↑) state; consequently, if r_{A} and r_{B} are jointly odd (i.e., even/odd or odd/even), then the coupling spin qubit q_{C} will be in the |↓) state. Measuring the coupling spin qubit q_{C}, then, entangles the resonator modes r_{A} and r_{B} in the parity basis.

The process for performing a CNOT gate that builds on this spin-bus entanglement scheme is as follows:
1. perform a parity operation P with result p₁;
2. tune the coupling spin qubit q_{C} to dispersively interact with r_{B} (far detuned from r_{A}); and
3. interact for time τ to perform an X gate.
   Simulating this for realistic parameters yields an expected decay in entanglement fidelity for increasing photon number. However, for realistic Qᵣₑₛ of 10⁶-10⁷ and n̅=2.5, the entanglement fidelities range from 87% to 98%. Note also that the X gate can be replaced with any arbitrary single-qubit gate. Since a single two-qubit entangling gate and local operations are sufficient for universal quantum computation, this gives us the tools for implementing quantum computations on our bosonic encoding platform.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein.

The foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A bosonic encoding device comprising:
a first nanomechanical resonator supporting a first set of bosonic modes;
a first spin qubit, coupled to the first nanomechanical resonator, to manipulate and read out quantum information encoded in the first set of bosonic modes;
a second nanomechanical resonator supporting a second set of bosonic modes;
a second spin qubit, coupled to the second nanomechanical resonator, to manipulate and read out quantum information encoded in the second set of bosonic modes; and
a third spin qubit, coupled to the first nanomechanical resonator and the second nanomechanical resonator, to controllably couple the first set of bosonic modes with the second set of bosonic modes so as to entangle the quantum information of the first set of bosonic modes with the quantum information of the second set of bosonic modes.

2. The bosonic encoding device of claim 1, wherein the first nanomechanical resonator and the second nanomechanical resonator occupy respective areas each less than 10,000 μm².

3. The bosonic encoding device of claim 1, wherein the first nanomechanical resonator and the second nanomechanical resonator are in a one-dimensional array of nanomechanical resonators.

4. The bosonic encoding device of claim 1, wherein the first nanomechanical resonator and the second nanomechanical resonator are formed in a diamond substrate and the first spin qubit, the second spin qubit, and the third spin qubit are each one of a silicon vacancy (SiV) or tin vacancy (SnV) formed in the diamond substrate.

5. The bosonic encoding device of claim 1, wherein the first nanomechanical resonator has a quality factor of 10⁵ to 10⁷.

6. The bosonic encoding device of claim 1, wherein the first set of bosonic modes is detuned in frequency from the second set of bosonic modes.

7. The bosonic encoding device of claim 1, wherein the third spin qubit is formed in a bridge connecting the first nanomechanical resonator and the second nanomechanical resonator.

8. The bosonic encoding device of claim 1, further comprising:
a first piezoelectric transducer, mechanically coupled to the first nanomechanical resonator, to drive the first set of bosonic modes; and
a second piezoelectric transducer, mechanically coupled to the second nanomechanical resonator, to drive the second set of bosonic modes.

9. The bosonic encoding device of claim 1, further comprising:
a first superconducting loop, in electromagnetic communication with the first spin qubit, to tune a resonance of the first spin qubit;
a second superconducting loop, in electromagnetic communication with the second spin qubit, to tune a resonance of the second spin qubit; and
a third superconducting loop, in electromagnetic communication with the third spin qubit, to tune a resonance of the third spin qubit.

10. A method of entangling quantum information in a first set of bosonic modes supported by a first nanomechanical resonator with quantum information in a second set of bosonic modes supported by a second nanomechanical resonator with a spin qubit located where the first set of bosonic modes overlap with the second set of bosonic modes, the method comprising:
encoding quantum information in the first set of bosonic modes;
encoding quantum information in the second set of bosonic modes; and
tuning the spin qubit to interact dispersively with the first set of bosonic modes and the second set of bosonic modes, thereby entangling the quantum information encoded in the first set of bosonic modes with the quantum information encoded in the second set of bosonic modes.

11. The method of claim 10, wherein encoding the quantum information in the first set of bosonic modes comprises straining the first nanomechanical resonator with a first piezoelectric transducer at a first frequency.

12. The method of claim 11, wherein encoding the quantum information in the second set of bosonic modes comprises straining the second nanomechanical resonator with a second piezoelectric transducer at a second frequency different than the first frequency.

13. The method of claim 10, wherein tuning the spin qubit comprises applying a magnetic field and/or a microwave field to the spin qubit.

14. The method of claim 10, further comprising:
manipulating the quantum information encoded in the first set of bosonic modes with an ancilla spin qubit in the first nanomechanical resonator.

15. The method of claim 10, further comprising:
reading out the quantum information encoded in the first set of bosonic modes with an ancilla spin qubit in the first nanomechanical resonator.

16. A bosonic encoding device comprising:
an array of nanomechanical resonators, each nanomechanical resonator in the array of nanomechanical resonators supporting a corresponding set of bosonic modes and containing a corresponding ancillary spin qubit to manipulate and read quantum information encoded in the corresponding set of bosonic modes; and
an array of ancillary coupling spins, each ancillary coupling spin controllably coupling of the sets of bosonic modes of an adjacent pair of nanomechanical resonators in the array of nanomechanical resonators.

17. The bosonic encoding device of claim 16, wherein the array of nanomechanical resonators is formed in a substrate and the ancillary coupling spins are formed in respective bridges connecting respective adjacent pairs of nanomechanical resonators in the array of nanomechanical resonators.

18. The bosonic encoding device of claim 16, wherein the sets of bosonic modes of the adjacent pairs of nanomechanical resonators are detuned from each other.

19. The bosonic encoding device of claim 16, wherein each nanomechanical resonator in the array of nanomechanical resonators occupies an area of less than 10,000 μm².

20. The bosonic encoding device of claim 16, further comprising:
an array of piezoelectric transducers, each piezoelectric transducer in the array of piezoelectric transducers configured to drive a corresponding nanomechanical resonator in the array of nanomechanical resonators.
